(19) United States
(12) Patent Application Publication
(10) Pub. No.: US 2002/0068111 A1
(43) Pub. Date: Jun. 6, 2002

(54) Composition and method for preventing, delaying, or reducing alcohol intoxication

(76) Inventor: Robert D. Gwynn, Pompano Beach, FL (US)

Correspondence Address: LOTT & FRIEDLAND, P.A., P.O. Box 141098, Coral Gables, FL, 33114-1098, US

(21) Appl. No.: 09/730,714

(22) Filed: Dec. 6, 2000

(51) Int. Cl. A23L 1/00

(52) U.S. Cl. 426/2; 426/578; 426/804; 426/629

(57) ABSTRACT

Composition and method comprising complex carbohydrates and dietary fats for reducing, delaying or preventing alcohol intoxication.

### FIELD OF THE INVENTION

The present invention is a dietary supplement for reducing, delaying or preventing the intoxicating effects of ethanol. Every year countless numbers of people suffer harm caused by ethanol intoxication. In response, the state, local and federal governments pass laws and regulations to limit alcohol consumption. Examples include the driving while intoxicated driving under the influence laws present in every state. Violators who are convicted under these laws often face substantial criminal penalties including fines, community service, and imprisonment. Additionally, a person convicted under these laws will face substantial increases in their automobile insurance. In certain occupations, such conviction may cost a person their job. Even if not guilty of criminal offenses, a person consuming alcoholic beverages may embarrass themselves socially such that it will impair their relationship with employers, coworkers, and family members.

In spite of the potential downside to alcohol consumption, our society encourages alcohol consumption as part of daily activity. We consume alcoholic beverages such as beer, wine, and mixed drinks with our meals. Consumption of alcoholic beverages is deeply ingrained in our social pastimes such as parties, sporting events and concerts.

Consumption of alcoholic beverages may be beneficial. Moderate consumption is associated with reduced cardiac problems. Many people find the moderate consumption of alcoholic beverages to be relaxing.

There is a long felt need for a means to enable safe, moderate alcohol consumption while reducing the alcohol consumer's risk of suffering harm due to careless over-imbibing.

A number of methods for reducing intoxication have been described in the art:

U.S. Pat. No. 5,968,727 entitled Pyruvate Compounds and Methods for Use Thereof, issued to Henri Brunengraber, et al., teaches and claims the use of pyruvate esters to reduce ethanol intoxication.

U.S. Pat. No. 5,547,671 entitled Anti-Intoxication Composition, issued to Phu Duthinh, claims daidzin and daidsein (herbal extracts) to control alcohol metabolism.

U.S. Pat. No. 4,368,206 entitled Method for Treating Alcoholism and Eliminating and Preventing Alcohol Intoxication, issued to Emanuel Revici, teaches and claims the use of oxidized fatty acids or fatty acid esters to reduce the manifestations of alcohol intoxication and alcoholism.

U.S. Pat. No. 3,996,370 entitled Antagonism of Ethanol Intoxication with 4{8(4,5-dihydro-2-1H-imidazoyle)methoxy(9-N,N,2-trimethylbenzenamine, issued to Abdulmunien Abdallah, teaches and claims the use of 4{8(4,5-dihydro-2-1H-imidazoyle)methoxy{9-N,N,2-trimethylbenzenamine to reduce alcohol intoxication.

U.S. Pat. No. 4,020,167 entitled Ethanol intoxication with 2[(3-trifluoromethylphenoxy)methyl]-2-imidazoline, issued to Abdulmunien Abdallah, teaches the use of 2[(3-trifluoromethylphenoxy)methyl]-2-imidazoline to reduce alcohol intoxication.

U.S. Pat. No. 3,860,719 entitled Antagonism of Ethanol Intoxication with 2-{8(3,4-dichlorophenoxy) methyl(9-2-imidazoline, issued to Franklin Marshall, teaches and claims the use of 2{8(3,4-dichlorophenoxy) methyl {9-2-imidazoline to reduce alcohol intoxication.

U.S. Pat. Nos. 4,565,689 and 5,366,689 entitled Method for Treating the Effects of Alcohol, issued to Emanuel Revici, teach and claim the use of organic compounds containing bivalent sulfur atoms to control intoxication and craving for ethanol.

The scientific literature discloses that diet can affect alcohol intoxication.

Zacchia, C., et al. Effect of Sucrose Consumption on Alcohol-Induced Impairment in Male Social Drinkers, 105(1) Psychopharmacology 49-56 (1991) discloses that co-consumption of sucrose (table sugar) with ethanol reduces the intoxicating effects of ethanol without reducing blood alcohol levels.

McFarlane, A., et. al. How Does Dietary Lipid Lower Blood Alcohol Concentrations? 2791 Gut 15-18 (January 1986) discloses that consumption of dietary fats after consumption of alcohol delays alcohol absorption by delaying emptying of the stomach.

Finnigan, F., et al., Effects of Meal Composition on Blood Alcohol Level, Psychomotor Performance and Subjective State after Ingestion of Alcohol 31(3) Appetite 361-75 (December 1998) discloses that subjects given a high carbohydrate based meal have lower blood alcohol concentrations than subjects given no food or a meal with a high protein content.

Han, R. G., et al., Eating a Meal Increases the Clearance of Ethanol Given by Intravenous Infusion 29 Alcohol 673-7 (November 1994) discloses that alcohol is cleared from the blood stream about sixty percent faster in subjects given a meal versus fasted subjects.

Millar, K., et al., Reduction of Alcohol-Induced Performance Impairment by Prior Ingestion of Food 83 Br. J. Psychol. 261-78 (May 1992) suggests that alcohol impairment and blood alcohol levels are significantly reduced in fed subjects versus fasted subjects.

Many of the above referenced pharmaceutical compositions and/or methods are not available to consumers. The patents describe pharmaceutical type products which are either not approved, or if approved are only available through a prescription. Many of the methods pertain to treatment of chronic alcoholism, and not to the prevention of occasional intoxication. Consumption of a full meal may not be an option for many people prior to consumption of alcohol. As such there is a long felt need for a convenient composition that is readily available to consumers to prevent, delay or reduce the intoxicating effects of alcohol. In particular, there is a need for a convenient, safe, natural composition which reduces the effects of alcohol intoxication.

### BRIEF DESCRIPTION OF THE INVENTION

It has been surprisingly discovered that the administration of a mixture of complex carbohydrates and dietary fats serves to significantly reduce the intoxicating effects of moderate ethanol consumption. This formulation can be administered in liquid, slurry, or solid forms.

The present invention features a novel dietary supplement, which is used for a treatment or prevention of alcohol intoxication by a person who intends to consume alcohol.

Optionally, the invention can comprise nutritionally acceptable excipients such as but not limited to flavoring agents, thickening and emulsifying agents, diluents, or bulking agents.

In another aspect, the invention features the supplement which includes, in addition to the components described above (e.g., complex carbohydrates and lipids) vitamins and minerals in accordance with, or approximately, the Recommended Dietary Allowance (RDA)(now called the Reference Daily Intake (RDI)).

The invention also features, a method of reducing, delaying or preventing alcohol intoxication in a person consuming alcohol by administering a supplement to the person, the dietary supplement.

The following description and non-limiting examples further elucidate the invention.

### DETAILED DESCRIPTION OF THE INVENTION

The supplement of the invention is made by blending dietary fats, complex carbohydrates, any additional additives, and homogenizing the mixture.

Although not wishing to be bound by theory, it is believed that the formulation of dietary fats and complex carbohydrates of the invention prevents or treats alcohol intoxication by delaying absorption of alcohol from the stomach and small intestine. Complex carbohydrates are hydrolyzed by intestinal enzymes more slowly than other forms of carbohydrates, resulting in delayed intestinal absorption long after the formulation is ingested. Dietary fats in the form of medium and long chain triglycerides are added to the dietary supplement to delay overall gastric emptying, so that all of the aforementioned processes occur more slowly.

The dietary fat source of the invention may comprise a mixture of dietary oils suitable for human consumption. Such sources of dietary fats include: coconut oil, macadamia oil, palm oil, palm kernel oil, canola oil, safflower oil, sunflower oil, corn oil, olive oil, menhaden oil, evening primrose oil, peanut oil, or mixtures thereof. The dietary fat source should be added to the dietary supplement in the amount sufficient to delay gastric emptying. In a preferred embodiment, the dietary fat is present in a ratio from about 5:1 to 1:5 to the complex carbohydrate. Preferably, in a ratio of 2:1 to 1:2 and most preferably about 2:1 dietary fats to complex carbohydrates. Olive oil is a preferred source of dietary fats in the present invention.

Pasta is a preferred source of complex carbohydrate because the carbohydrate content is relatively uniform, its rate of metabolism is both known and consistent, and it can be readily formulated into a variety of forms. Additional sources of complex carbohydrates, which can be used in the practice of the present invention include but are not limited to: nuts, barley, bulger, cornstarch, parboiled rice, dried legumes, or mixtures thereof.

Emulsifiers, including but not limited to lecithin, may be added to the dietary supplement of the invention to improve stability and/or texture.

Flavoring may also be added to the dietary supplement of the invention to make it more palatable. Flavoring can be in any form acceptable for food products, including but not limited to: spices, tomato, flavored extracts, volatile oils, chocolate flavoring, peanut butter flavoring, cookie crumbs, vanilla or any commercially available flavoring.

Preservatives may also be added to formulation of the invention to extend the shelf life. Preferably, preservatives such as potassium sorbate, sodium sorbate, potassium benzoate, sodium benzoate or calcium disodium EDTA are used.

In addition to the carbohydrates, any dietically acceptable sweeteners, such as but not limited to, saccharides, cyclamates, or aspartame, may also be added to the formulation of the invention.

It will be readily apparent to one of skill in the art that a number of formulations are possible within the ratios of complex carbohydrates to dietary fats disclosed herein. The invention may be embodied in solid, semi-solid and liquid forms. It could take the form of a beverage, food bar, snack food, etc. The following are for example and are not a limitation on the possible embodiments.

The dietary supplement of the present invention should be administered in an amount sufficient to delay or reduce the intoxicating effects of alcohol consumption. Such effects can be readily achieved by administering from 5-20 grams of dietary fats and from 5-20 grams of complex carbohydrates to a person who intakes, consumes or is consuming alcohol containing beverages. Most preferably, a person should be administered approximately 8 grams of complex carbohydrates and approximately 16 grams of dietary fat.

A simple formulation according to the present invention can be made as follows: Cook 65 grams of dried pasta to yield approximately 1 cup cooked pasta. Place the cooked pasta in a blender with 150 ml of olive oil, 200 ml of water and 45 ml of tomato paste and 6 grams of table sugar. Homogenize the composition until a slurry is formed. The resulting composition should be refrigerated until consumed.

To reduce, delay or prevent the onset of intoxication, the dietary supplement of the invention is preferably administered to a person prior to consumption of alcohol. Preferably immediately prior to an hour before consumption of alcohol and most preferably 5 to 10 minutes before. The quantity administered should be sufficient to delay absorption of the alcohol from the small intestine and to delay emptying of the stomach. Preferably between 30 ml and 100 ml of the formulation of the Example should be administered and most preferably 45-85 ml.

The formulation disclosed in the Example was provided to 10 social drinkers. Each subject was asked to consume 75 ml of the formulation of the Example 15 minutes prior to consumption of their alcoholic beverage of choice and to evaluate how alcohol affected them after taking the formulation versus consumption of alcohol without consumption of the formulation.

Subject 1 was a 65 year old male approximately 250 pounds body weight. Subject was administered 75 ml of the formulation of the Example approximately 15 minutes before the consumption of an alcoholic beverage. Subject consumed 3 vodka on the rocks over approximately 1 hour and was asked to evaluate whether he experienced a reduction in the effects of intoxication normally experienced. Subject observed a delayed onset of intoxication and felt a 25-50% reduction in the intoxicating effects. Subject felt almost no intoxicating effect.

Subject 2 was a 55 year old female, approximately 150 pounds body weight. Subject was administered 75 ml of the formulation of the Example approximately 15 minutes before the consumption of an alcoholic beverage. Subject consumed 5 glasses of wine over a period of about 1 hour and was asked to evaluate whether she experienced a reduction in the effects of intoxication normally experienced. Subject stated that she felt no effect from the alcohol. On another date, subject repeated the test with an identical quantity of wine and again observed no intoxicating effect the effect from the alcohol.

Subject 3 was a 60 year old male, approximately 275 pounds body weight. Subject was administered 75 ml of the formulation of the Example approximately 15 minutes before the consumption of an alcoholic beverage. Subject consumed 6 beers over a period of about 1 hour and was asked to evaluate whether he experienced a reduction in the effects of intoxication normally experienced. Subject observed a delayed onset of intoxication and felt a 25-50% reduction in the intoxicating effects of the alcohol. Subject repeated the test on another date with an identical quantity of beer and again reported a 25-50% reduction in the intoxicating effects of the alcohol.

Subject 4 was a 62 year old male, approximately 190 pounds body weight. Subject was administered 75 ml of the formulation of the Example approximately 15 minutes before the consumption of an alcoholic beverage. Subject consumed 2 vodka on the rocks over a period of about 1 hour and was asked to evaluate whether he experienced a reduction in the effects of intoxication he would normally experience. Subject observed a delayed onset of intoxication and felt a 20-30% reduction in the intoxicating effects of the alcohol.

Subject 5 was a 65 year old male, approximately 170 pounds body weight. Subject was administered 75 ml of the formulation of the Example approximately 15 minutes before the consumption of an alcoholic beverage. Subject consumed 3 scotch and waters over a period of about 1 hour and was asked to evaluate whether he experienced a reduction in the effects of intoxication he would normally experience. Subject observed a delayed onset of intoxication and felt a 25-50% reduction in the intoxicating effects of the alcohol.

Subject 6 was a 75 year old male, approximately 220 pounds body weight. Subject was administered 75 ml of the formulation of the Example approximately 15 minutes before the consumption of an alcoholic beverage. Subject consumed 2 scotch and waters over a period of about 1 hour and was asked to evaluate whether he experienced a reduction in the effects of intoxication he would normally experience. Subject observed a delayed onset of intoxication and felt a 25-50% reduction in the intoxicating effects of the alcohol. Subject commented that the reduction felt equivalent to eating a full meal.

Subject 7 was a 72 year old female, approximately 140 pounds body weight. Subject was administered 75 ml of the formulation of the Example approximately 15 minutes before the consumption of an alcoholic beverage. Subject consumed 2 vodka on the rocks over a period of about 1 hour and was asked to evaluate whether she experienced a reduction in the effects of intoxication she would normally experience. Subject felt no intoxicating effects from the alcohol.

Subject 8 was a 61 year old female, approximately 95 pounds body weight. Subject was administered 75 ml of the formulation of the Example approximately 15 minutes before the consumption of an alcoholic beverage. Subject was administered 2 glasses of wine over a period of about 1 hour and was asked to evaluate whether she experienced a reduction in the effects of intoxication. Subject observed a delayed onset of intoxication and felt no effect from the alcohol. Subject is normally affected by one glass of wine.

Subject 9 was a 21 year old male college student, approximately 190 pounds body weight. Subject was administered 75 ml of the formulation of the Example approximately 15 minutes prior to the consumption of an alcoholic beverage. Subject consumed 3 beers over a period of 1 hour and was asked to evaluate whether he experienced a reduction in the effects of intoxication normally experienced. Subject experienced a 25-50% reduction in effect from the intoxicating effect of the alcohol.

Subject 10 was a 72 year old male, approximately 180 pounds body weight. Subject was administered 75ml of the formulation of the Example approximately 15 minutes before the consumption of an alcoholic beverage. Subject was administered 2 double gin martinis and was asked to evaluate whether he experienced a reduction in the effects of intoxication. Subject experienced no intoxicating effects from the alcohol. Subject repeated the test 15 times on other occasions and observed a reduction of intoxication of at least 25% to 50% on each occasion.

The above examples demonstrate a dramatic reduction in the intoxicating effects of ethanol when, the dietary supplement of this invention was administered.

What is claimed is:

1. A dietary supplement comprising sufficient amounts of complex carbohydrate and dietary fats to prevent, delay or reduce the intoxicating effects of alcohol in a person consuming alcohol.

2. The dietary supplement of claim 1 comprising:
about 10-75% by weight lipid; and
about 10-60% by weight complex carbohydrate,
wherein the dietary supplement is used for the reduction of alcohol intoxication in a person consuming alcohol.

3. The dietary supplement of claim 1, wherein the ratio by weight of complex carbohydrate to dietary fat is from 1:5 to 5:1.

4. The dietary supplement of claim 1, wherein the ratio by weight of complex carbohydrate to dietary fat is from about 1:2 to 2:1

5. The dietary supplement of claim 1, wherein the ratio by weight of complex carbohydrate to dietary fat is 1:2.

6. The dietary supplement of claim 1, wherein the complex carbohydrate is selected from the group consisting of uncooked corn starch, nuts, barley, bulgur, pasta, parboiled rice, dried legumes and mixtures thereof.

7. The dietary supplement of claim 1, wherein the complex carbohydrate is pasta.

8. The dietary supplement of claim 1, wherein the dietary oil is selected from at least one of the following: coconut oil, palm oil, palm kernel oil, canola oil, safflower oil, sunflower oil, corn oil, olive oil, menhaden oil, peanut oil.

9. The dietary supplement of claim 1, wherein the dietary oil is olive oil.

10. The dietary supplement of claim 1, wherein the complex carbohydrate is pasta and the dietary oil is olive oil.

11. The dietary supplement of claim 1, wherein the composition further comprises sources of vitamins, minerals or herbal extracts.

12. The dietary supplement of claim 1, wherein the composition further comprises one or more of the following: emulsifier or flavoring.

13. The dietary supplement of claim 1, wherein the dietary oil is in an amount sufficient to delay gastric emptying.

14. A method of preventing, delaying or reducing alcohol intoxication in a person consuming alcohol comprising administering a dietary supplement to the patient, the dietary supplement comprising sufficient amounts of complex carbohydrates and dietary fats to delay or prevent the intoxicating effects of alcohol.

15. The method of claim 14 wherein the dietary supplement contains about 10-75% by weight lipid; and about 10-60% by weight complex carbohydrate.

16. The method of claim 14, wherein the dietary supplement contains dietary fats and complex carbohydrates in the ratio of approximately 2:1.

17. The method of claim 14 where the dietary supplement is administered approximately 0 to 60 minutes prior to the consumption of alcohol.

18. The method of claim 14, where the dietary supplement is administered approximately 5 to 10 minutes prior to the consumption of alcohol.

19. The method of claim 14, where the dietary supplement is administered approximately 0 to 15 minutes prior to the consumption of alcohol.

20. The method of claim 14, wherein the dietary fat is selected from at least one of the following: coconut oil, macadamia oil, palm oil, palm kernel oil, canola oil, safflower oil, sunflower oil, corn oil, olive oil, menhaden oil, and/or peanut oil; and wherein the complex carbohydrate is selected from at least one of the following: uncooked corn starch, nuts, barley, bulgur, pasta, parboiled rice, dried legumes and mixtures thereof.

21. The method of claim 14, wherein the source of a dietary fat is olive oil and the complex carbohydrate is pasta.

22. The method of claim 14, wherein the dietary fat is present in an amount sufficient to delay gastric emptying in the patient.

23. A dietary supplement for preventing, delaying or reducing the intoxicating effects of alcohol comprising approximately 8 grams of complex carbohydrates from pasta and approximately 16 grams of dietary fats from olive oil.
